(19) United States
(12) Patent Application Publication
(10) Pub. No.: US 2021/0142584 A1
(43) Pub. Date: May 13, 2021

(54) TICKETING SYSTEM AND METHOD

(71) Applicant: DIRECT TECHNOLOGY HOLDINGS INC, Roslyn Heights, NY (US)

(72) Inventors: Tony ALEX, New York, NY (US); Michael GIANNONE, Levittown, NY (US); Peter J. DEGEN, Huntington, NY (US)

(73) Assignee: DIRECT TECHNOLOGY HOLDINGS INC, Roslyn Heights, NY (US)

(21) Appl. No.: 17/074,889

(22) Filed: Oct. 20, 2020

Related U.S. Application Data
(60) Provisional application No. 62/932,317, filed on Nov. 7, 2019.

(51) Int. Cl. G07B 15/04; G07F 9/00

(52) U.S. Cl. CPC G07B 15/04; G07F 9/009

(57) ABSTRACT

There is a system and process for pre-ticketing a user so that the ticket is printed before the user enters and/or pays for admission to an area such as an arena, a park or an event. There is also a system which can be used to track the location of a ticket purchaser as well to determine whether the ticket purchaser has entered an area only after the ticket purchaser has paid for the ticket.

### BACKGROUND OF THE INVENTION

The invention relates to a ticketing system and method which is configured to invert the current state of the art ticketing process by first printing out a ticket, while next customer is advancing to payment gate, giving just-printed ticket to the customer, collecting the fee from the customer, and then allowing customer through the gate or entrance. This new process eliminates the dead-time in current systems which require printing ticket while customer is at payment station waiting for ticket, after customer has made payment. This modest and unobvious change has a large benefit of reducing waiting times at payment stations.

In the past, when a patron was interested in entering a venue, such as a parking lot, an arena, a stadium or similar controlled area, the patron would line up in a line, arrive at a ticketing gate or ticketing kiosk and then pay for a ticket. Next, the ticketing attendant, would print the ticket. However, in instances where there is high patron volume, and a significant amount of traffic, the time that it would take to print a ticket after the purchase of a ticket would hinder the movement of the line. For example, the time to print a ticket after the purchase of the ticket could take between 5-15 seconds or more. This time to print the ticket would result in delays between each interaction between the ticketing attendant and the patron. In a venue with high traffic, this 5-15 second delay (or more) for each interaction would multiply and could result in significant delays in processing the entrance of patrons to a controlled area.

In addition, another problem with this type of process is that the ticket is printed only after it is purchased such that if the arena or controlled area has a limited capacity, the number of tickets purchased could exceed the capacity of the controlled area such as a parking lot.

Therefore, there is a need for a streamlined and efficient ticketing and purchasing process that identifies patrons before they arrive to purchase a ticket at a ticketing attendant so that the ticket is printed and counted before the patron arrives at the ticketing attendant to purchase the ticket. This streamlined process thereby saves time for each patron as well as simultaneously counts the number of tickets printed before their purchase.

### SUMMARY OF THE INVENTION

At least one embodiment of the invention involves a process for pre-printing a ticket for a venue/event—as the next customer in line approaches the payment station. The process involves first identifying the venue, then logging the date and time for a particular event. Next depending on the event, the system limits or pre-sets the number of entrants or customers to an event. Next, once the time, date, location, and event type is identified along with the number of entrants, the system is ready to receive ticketers.

Next, the system or its administrator identifies potential customers to an event. By the identification of a customer or potential ticket purchaser, the system and or official who is a user of the system pre-prints a ticket on demand for the person entering the arena. Next, the user of the system would distribute the ticket to the patron. The user of the system would then take payment and then release the customer or ticket purchaser to the event. Next, the ticket customer would have open access to the event while still having his or her custom printed ticket in their possession. Thus, this process is set up so that with a pre-printed ticket, the line would flow much faster and then this system would be able to process the patrons in less time. Thus, in a pre-set period of time the system could process more patrons and then allow more of these patrons into an arena or event.

This system and process is particularly suited for parks, campgrounds—public beaches where capacity is fixed and the number of entry points are constrained for a variety of reasons, all of which contribute to long lines at the point of entry.

Typically, in these venues, customers enter, stay and leave at variable times leading to a constantly changing occupancy count depending on the instant customer inflow and outflow. Efforts to maximize attendance require maintaining an accurate instant count of the present customers inside the venue at a particular time and which are tested against maximum capacity. This leads to the venue monitoring the number of net customers in the venue so that there can be an efficient management of such venues. The newly described ticketing system and method is especially effective in achieving this goal.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a flow chart of a first embodiment of the invention;

FIG. 2 is a plan view of a layout of the system at an event or venue;

FIG. 3 is a layout of the system or computer network for use at a venue;

FIG. 4A is a schematic block diagram of the electronic components of a portable electronic device used for the venue;

FIG. 4B is a schematic block diagram of an alternative mobile device;

FIG. 5 is a schematic block diagram of the layout of a server for use in the system or computer network of FIG. 3;

FIG. 6 is an alternative flow chart for processing ticketers;

FIG. 7 is a flow chart of another embodiment of a process for expediting a ticket sale;

FIG. 8 is a plan view of a pre-defined area for a ticket sale;

FIG. 9 is a schematic block diagram of a computer network for use with the process shown in FIG. 7;

FIG. 10 is a plan view of another embodiment with bluetooth portable ticket printers;

FIG. 11 is a block diagram of the network having bluetooth portable ticket printers.

### DETAILED DESCRIPTION OF PREFERRED EMBODIMENTS

Referring to the drawings, FIG. 1 shows a first flow chart of one embodiment of the invention wherein the process starts with a first step S1, wherein the system sets a venue such as a park, a concert hall, a sports stadium or other type of venue requiring an entrance fee or ticket. During this step the information about the venue is input into the system's database. One important characteristic of the venue information includes the number of parking spots in the venue. In this way the system limits the number of tickets that are printed for the venue. In this way the system keeps the venue from becoming too overcrowded. Other features of the venue can include its location, the number of entrances and location of the entry points.

Next, in step S2, the system logs the date of the event at the venue. This step includes also optionally the step of logging a pre-defined time for the event as well. This time can be a window of time or a particular pre-set time. The window of time can be 8 A.M.-1:00 P.M. for example or 2:00 P.M.-6:00 P.M. or any other type of pre-set time. Alternatively, there is simply a start time logged such as 1:00 P.M. Next, in step S3 the system catalogs and logs the number of customers to an event. Next, once the venue, time/date/ and number of customers or ticketers for an event are set the system is ready to receive future ticketers. By controlling the time of entry, the ticket printing system limits the time for the printing of entry tickets into the venue as well. Thus, the system is used to allow select entry for autos and other vehicles into a parking lot. However, if a customer has purchased a pre-purchased and printed ticket they will be directed towards a different venue.

Alternatively, the system can be set up simply to print tickets without any of the information obtained in steps S1-S3 as well. This system then leads to a printing on demand system which prints tickets and then distribute them based upon the capacity of a venue.

Next, in step S4 the ticket agent identifies the next party/customer entering an area and then identifies the next party entering the area and then based upon the capacity of the area, the ticket is printed and then the host has a pre-printed ticket ready for that party/customer.

Next the user or host prints a ticket in step S5. The printing of the ticket includes custom information on the ticket such as the event, the venue, the time and date of the event as well as even identifying information about the future customer. The ticket can contain scannable information such as a barcode or 2d barcode which can be scanned by a user's portable device such as portable device 30 or 36

Next, once the ticket is printed, it is distributed to a user in step S6. Next, in step S7 the system takes payment for receipt of the ticket. The payment can be any form of payment such as cash, credit card, check, electronic transfer etc. For example, in at least one embodiment, the user scans the ticket with his or her portable electronic device and then issue payment for the ticket to the host. The host would then confirm receipt of payment of the ticket and then allow the user to enter into a pre-set area. Thus, the holder of the ticket would be released into the area in step S8 wherein they would be provided with open access to the area in step S9. Alternatively, if the user or host does not receive payment from the party that received the ticket, in step S10, then the host removes the patron or ticket holder from the entrance or arena in step S11.

FIG. 2 is a schematic block diagram of an area or arena for entrance as described above. For example, there is a venue 10 having a pre-defined area 11 which includes a guard house 12 and a gate 24. The gate includes a hinge or lever 22 and a motor or mechanism 20 set to selectively allow users to enter the area. An attendant, user or host 14 having a portable electronic device 15 is set to distributed tickets and well as to confirm the receipt of payments for receipt of the tickets such as a ticket 19. A printer 59 can be stored inside of guard house 12 and be configured to print a ticket such as ticket 19 which in at least one embodiment includes information relating to the time, date, location, and event at a venue such as venue 10. The ticket can even include identifying information relating to the customer such as a unique identifying number. Once the ticket is handed to the participant 32, that participant can provide payment information to the host. Once the attendant 14 receives confirmation of the payment, the attendant raises or open the gate 24. Gate 24 is movable via hinge 22 and is controlled by drive 20. Thus, the attendant selectively allows a ticket purchaser in after they have paid for the ticket that they have previously received. This pre-defined area can include a pre-set number of parking spaces defined by the dash dotted lines. For example, there are 10 different parking places indicated in this pre-defined region including spots 11a, 11b, 11c, 11d, 11e, 11f, 11g, 11h, 11i and 11j. Thus, the system prints only those tickets that would accommodate these spots so that the lot or pre-defined area is not oversold.

In addition, payment can also be made via electronic device 30 making a payment through a computer network (See FIG. 3) such that the payment can be made online by scanning a ticket such as ticket 19 and then authorizing payment based upon this ticket. Then, with the purchase in hand, the user such as user 32 having electronic device 30 can be let inside the area 11. Thus, an auto 34 can move inside of the area, and find a spot inside of pre-defined area 11, and then be recorded as occupying that spot until the auto 34 is recorded as leaving.

FIG. 3 is a schematic block diagram of a computer network used to implement the network shown in FIG. 1. For example, there is at least one server 51 which can include application server 53 and database server 54. The application server is configured to perform many of the steps outlined in FIG. 1 whereas the database server is configured to store that data associated with each user, the venue, the time and date of the event as well as the activities associated with the event. The server(s) 51, are in communication with a computer network such as the internet 56. Connected to the internet are a plurality of emitters such as Bluetooth emitter, WIFI emitters 61, cell towers 62, a plurality of hand-held devices 30, 36, 15 and 18 as well as printer 59. In addition, the application server and the individual portable hand-held devices are in communication with GPS 60 so that these devices can be located in a space. The system can detect the presence of these portable devices 30, 36, and 15 in a particular region, and in the case of hand-held devices 30 and 36 the system sends tickets to printer 59 when devices such as devices 30 and 36 enter these pre-defined regions.

FIG. 4A is a view of the inner components of any one of the electronic devices shown in FIG. 3. For example, there is a motherboard 109, which can have a microprocessor 101, a memory 102, a mass storage 103 (hard drive), a power supply 104, a SIM card/CDMA card for cellular communications, a GPS communicator for communicating with a GPS satellite such as satellite 60, a video output 107 which outputs video images to video screen 100a. In addition, there is a WIFI/TCP/IP transceiver 108 which is configured to communicate via WIFI with a router and then with the internet such as internet 56. Additional components include a Bluetooth transceiver 110 as well as a microphone 111 and a speaker 112. There is also a camera video processor 109a as well as a camera 109b as well.

FIG. 4B is similar to that shown in FIG. 4A however this embodiment includes a nearfield chip 116 as well. The power supply 104 is configured to power the motherboard 109 and the components coupled to the motherboard are in communication with each other. Microprocessor 101 is configured to run any suitable application which is necessary to carry out or perform the steps outlined in FIG. 1 and in FIG. 6.

FIG. 5 is a block diagram of components that go into a server such as any—one of servers 51, 53, and 54 as well as computing device 18. With this embodiment there is a motherboard 209 which includes a microprocessor 201, a memory 202, a mass storage 203, a power supply 204, a video output 207, and a WIFI/TCP/IP transceiver 208. This device also includes additional input output ports such as a first input/output port for communicating with any one of a keyboard, mouse or any other object as well as a second input output port 210 for a keyboard/mouse or any other suitable connection. The power supply 204 can be plugged into a standard AC port and be used to power the motherboard 209 which powers all of the components. Each of these components are in communication with each other and the microprocessor 201 is configured to run many of the steps outlined in FIG. 1.

FIG. 6 is a flow chart for another simplified process according to the invention. With this process the system identifies a customer in step S101. Next, once the system identifies the customer, it prints a ticket in step S102. Identification of a customer can be when the customer's portable device or automobile or vehicle such as vehicle 34 or device—such as device 30, or 36 enters a pre-defined region. This information is then transported through a computer network such as the internet to server(s) 51. This could then trigger an automatic printing of a ticket. Next a party such as party 14 can distribute the printed ticket in step 103. Next, in step 104 the system can take payment such as via cash, check, or electronic payment. The electronic payment can be through standard wiring channels or transmission of a credit card transaction. Alternatively the portable device such as device 30 or 36 can scan the ticket, wherein the ticket can have an optional barcode or 2D barcode or some form of communication display to obtain the wiring or money transfer instructions, and then via the scan information send the money through these wiring instructions. Next, once the monetary transaction is completed, the attendant such as attendant 14 can release the customer in step S105 wherein the gate such as gate 24 is opened and then the user now has open access in step S106 to region 11.

FIG. 7 shows a modified view of another embodiment of the process, which is similar to the process shown in FIG. 1. All of the common steps of FIG. 7 are the same as recited in FIG. 1. With this embodiment, there is an additional step S3a wherein with the presence of a sensor, the sensor automatically detects the presence of a customer. The sensor which is shown as sensor 41 in FIG. 8 and sensor 41 in FIG. 9 then sends a signal either wirelessly or in a wired manner to a server such as application server 53 to then update the system as to an approaching customer. The attendant, or the system such as server 53 alone then identifies the customer in step S4. With this design the system alone such as server 53 in communication with a local computing device such as computing device 18 in communication with a printer 59 then prints a ticket or, the attendant then selectively prints the ticket. This type system then allow for the automatic printing of a ticket when the customer triggers the sensor such as sensor 41.

In addition, because this is an automatic system and/or process, this automatic system then allows for an automatic tracking of the number of customers in the pre-defined area in step S12. Then when a customer leaves the pre-defined area such as when the customer crosses a second sensor 42 at an exit, during step S13, this then causes the system such as application server 53 using microprocessor 101 to automatically deduct from the total number of customers present in the pre-defined area by the number of customers exiting the pre-defined area in step S14. With this new total of customers in the pre-defined area, the system in step S15 opens access to the pre-defined area for future customers.

In addition, with this design, as shown in FIG. 8, the autos 34 or customers which are funneled along a queue or line having barriers 48 and 49 then automatically trigger a sensor such as sensor 42 or sensor 42 (shown by dashed lines) because these sensors are present in the area of the line or queue that these autos or customers automatically pass. This then results in an orderly flow of traffic.

By virtue of pre-printing the ticket or receipt, the line that is associated with entering a venue moves more rapidly wherein an attendant such as attendant 14 as well as ticket purchasers 32 and 42 proceed through a grounds without having to wait for a ticket because the ticket is printed in advance of their arrival at a gate area wherein the user then enters the confined area. This system can be used for any point of purchase system such as for park areas, concerts, taking a ride share or taxi or any other type of purchase/receipt system or ticket/purchase/receipt system. Thus, this system results in a system that prints tickets on demand and also self regulates the number of customers in a venue.

In addition, because the system is designed to track the location of the ticket purchaser, the system also determines if a purchaser has entered a restricted area such as area 11 without first paying for admission as well. Determination of whether the user is lawfully or rightfully in a region can be based upon whether 1) the ticket has been pre-printed; 2) the ticket has been scanned by the user; 3) the ticket has been paid for by the user.

FIG. 10 is a plan view of another embodiment with bluetooth portable ticket printers. With this design, there are two different pre-defined areas or parking lots 110a and 110b which are respectively closed off by a gate such as gate 24a and 24b. Different attendants are now mobile such as attendants 14a, 14b, 14c, and 14d. These attendants each has their own bluetooth or wireless printer 81, 82, 83, and 84 respectively. The wireless printers 81, 82, 83, and 84 are configured to allow the different attendants to move about the grounds and to allow for multiple different pre-defined areas or parking lots to be serviced without an attendant booth. Each of these attendants such as attendants 14a, 14b, 14c, and 14d can communicate with their respective electronic device 15a, 15b, 15c, and 15d to inform a respective server of a new entrant into a pre-defined area. When each of the different parties in different cars come to the pre-defined area, a different attendant such as any one of attendants 14a, 14b, 14c, and 14d can print a ticket for entrance. At that time the attendants 14a, 14b, 14c, and 14d can collect payment from the participant upon handing the pre-printed ticket. Once that transaction has occurred, each of the attendants can then print the next ticket for the next entrant into a particular region.

FIG. 11 is a block diagram of the network having bluetooth portable ticket printers. This view is similar to the embodiment shown in FIG. 9 however in this embodiment, there is shown portable electronic devices 15a, 15b, 15c, and 15d which are each associated with the individual attendants 14a, 14b, 14c, 14d. In addition, there is also shown different printers 81, 82, 83, 84, wherein each of these different bluetooth or wireless printers which are portable ticket printers are associated with respective attendants 14a, 14b, 14c, and 14d. Each of these respective printers 81, 82, 83, 84 can be tethered (electronically wirelessly or in a wired manner connected) to associated electronic devices such as electronic devices 15a, 15b, 15c, and 15d. Thus, there is created a network of portable devices which are configured to communicate with at least one server such as server 51 or application server 53 or database server such that as each entrant is printed a ticket, that entrant is logged into the system and the total number of parties entering and leaving a pre-defined area such as pre-defined area 110a or 110b is tracked.

Some of the other benefits of this system include crowd control and a pre-set limit on the number of entry tickets issued to each vehicle. By limiting the number of tickets for the venue to each parking spot, the system limits the number of entrants of autos into a pre-defined area. The system then coordinates the number of tickets that are printed for each entrance into an area to restrict the number of entrants through a particular gate or location. In this way if certain parking lots are already full, the system restricts the number of tickets that are issued and the number of patrons entering a region.

Accordingly, while at least one embodiment of the present invention have been shown and described, it is to be understood that many changes and modifications may be made thereunto without departing from the spirit and scope of the invention as defined in the appended claims.

What is claimed is:

1. A system for printing tickets on demand and for tracking customers in a pre-defined area comprising:
at least one server having at least one processor for determining the number of customers in the pre-defined area;
at least one sensor for detecting the entrance of a customer to a pre-defined area;
at least one printer configured to print a ticket;
at least one payment system configured to take payment from a customer, wherein the at least one server is configured to print a ticket on demand when the at least one sensor detects that a customer is ready to enter the pre-defined area.

2. The system as in claim 1, wherein the sensor comprises at least one weight sensor for detecting when a customer crosses a point on a line.

3. The system as in claim 1, wherein the sensor is a button configured to be pressed by an attendant.

4. The system as in claim 1, wherein the sensor is an infrared scanner configured to determine when a customer crosses a point on a line.

5. The system as in claim 1, wherein the microprocessor is configured to determine the number of tickets sold in a single time period.

6. The system as in claim 1, further comprising at least one additional sensor positioned at an exit to the pre-defined area, wherein said at least one additional scanner is configured to determine whether a customer leaves the pre-defined area.

7. The system as in claim 6, wherein said at least one additional scanner is at least one of an infrared sensor, an optical sensor, a weight sensor, or a nearfield sensor.

8. The system as in claim 7, wherein the microprocessor is configured to determine a number of customers in a pre-defined area by simultaneously determining the number of current customers that have activated the sensor at the entrance, the number of current customers inside of the pre-defined area, and the number of current customers that have activated the sensor at the exit of the pre-defined area.

9. A process for providing a ticket in an expedited manner comprising the following steps:
setting a venue comprising a pre-defined area and recording said venue in a server using a microprocessor;
setting a time and date for a duration of a ticket for the venue using a microprocessor;
identifying at least one customer for the venue;
printing a ticket on demand upon identification of at least one customer;
distributing said ticket to the at least one customer; and
recording a payment from said at least one customer after the ticket is printed.

10. The process as in claim 9, wherein the process further includes the step of setting a limit of a number of customers allowed into a pre-defined area

11. The process as in claim 10, further comprising the step of tracking a number of customers leaving the pre-defined area.

12. The process as in claim 11, further comprising the step of determining via at least one scanner positioned at an exit of the pre-defined area the number of customers leaving the pre-defined area within a pre-set period of time.

13. The process as in claim 12, wherein the process further comprises simultaneously determining using a microprocessor a number of customers in a pre-defined area based upon a number of customers being scanned by at least one scanner at an entrance to the pre-defined area,

14. The process as in claim 12, further comprising the step of denying an entrance to a customer when a number of customers in the pre-defined area exceeds a pre-determined limit.

15. The process as in claim 14, further comprising the step of not allowing the printing of a ticket when the number of customers in the pre-defined area exceeds a pre-determined limit.
